(19) United States
(12) Patent Application Publication
(10) Pub. No.: US 2023/0286471 A1
(43) Pub. Date: Sep. 14, 2023

(54) CLEANING DEVICE FOR A VEHICLE SENSOR

(71) Applicant: VALEO SYSTEMES D'ESSUYAGE, La Verriere (FR)

(72) Inventors: Maxime BAUDOUIN, La Verriere (FR); Christophe CHASSAING, La Verriere (FR)

(73) Assignee: VALEO SYSTEMES D'ESSUYAGE, La Verriere (FR)

(21) Appl. No.: 18/006,247

(22) PCT Filed: Jul. 6, 2021
(86) PCT No.: PCT/EP2021/068606

§ 371 Date: Jan. 20, 2023

(30) Foreign Application Priority Data
Jul. 22, 2020 (FR) 2007688

(51) Int. Cl. B60S 1/56; B60S 1/54

(52) U.S. Cl. CPC B60S 1/56; B60S 1/54

(57) ABSTRACT

The present invention relates to a cleaning device for at least one vehicle sensor. The cleaning device includes at least one air-flow generator, at least one air-flow transport duct for conveying the air flow to the sensor from an exhaust port of the air-flow generator, the duct including at least one air-flow inlet opening and at least one air-flow outlet orifice. One cross section of the inlet opening of the duct is larger than one cross section of the outlet orifice of the duct.

### TECHNICAL FIELD

The present invention relates to the field of vehicle cleaning devices. More particularly, the invention concerns cleaning devices for a vehicle sensor, notably for sensors integrated in a module for assisting with the driving of vehicles.

### BACKGROUND OF THE INVENTION

With a view to the emergence of autonomous vehicles, year after year vehicles are increasingly being fitted with sensors for driving assistance modules in order to increase the safety of motorized vehicles, utility vehicles and special vehicles. These sensors are essential for applications such as, for example, rear assist, distance control radar, traffic sign detection, turn assist, blind spot assist, lane departure warnings, or 360° panoramic view. These sensors are, for example, cameras, optical sensors, LIDAR systems, radar systems or ultrasonic telemetry systems.

All of the information taken by the sensors is transmitted to a processing unit of the driving assistance module. The processing unit analyzes this transmitted information so as to then generate control instructions such that the module for assisting with the driving of the vehicle can adapt the driving of the vehicle to the environmental conditions.

Most of these sensors have transmitting and/or receiving outer surfaces on which foreign bodies can accumulate. These foreign bodies can be, for example, dust, dirt or water droplets. Left as they are on the outer surfaces of the sensors, the foreign bodies can falsify the information taken by the sensors, or even make the sensors inoperative. However, for a driving assistance module, notably in an autonomous vehicle, the information transmitted by the sensors must be reliable irrespective of the environmental conditions in which the vehicle is traveling.

There exist sensor cleaning devices the principle of which is based on spraying a washing product onto the transmitting and/or receiving outer surface from a spraying system comprising a pump.

A first drawback of such a solution is that these cleaning devices are large in size, which can be difficult to manage when multiple sensors are in the vicinity of one another.

A second drawback of such a solution is the specificity of each cleaning system for each given sensor. Thus, one cleaning system is developed for one sensor, thereby causing high production costs if a multiplicity of sensors are incorporated in one autonomous driving module.

An object of the present invention is to at least partially resolve the above problems and to also lead to other advantages by proposing a new type of cleaning device.

### SUMMARY OF THE INVENTION

The present invention proposes a cleaning device for at least one vehicle sensor, comprising at least one air stream generator, at least one air stream transport duct for conveying the air stream over the sensor from a discharge orifice of the air stream generator, the duct having at least one inlet opening for the air stream and at least one outlet orifice for the air stream. A cross section of the inlet opening of the duct is larger than a cross section of the outlet orifice of the duct.

The cross section of the inlet opening and the cross section of the outlet orifice are measured in a plane perpendicular to an overall flow direction of the air stream in the duct.

The air stream generator makes it possible to produce an air stream which is conveyed over the sensor to be cleaned by virtue of the air stream transport duct. The invention thus makes it possible to avoid the accumulation of foreign bodies on at least one sensor by blowing air, whilst still avoiding dirt caused by a washing liquid that has dried on the sensor. Moreover, the cross section of the inlet opening of the duct is larger than the cross section of the outlet orifice of the duct, the consequence of this being that the air stream has a higher velocity at the outlet orifice than at the inlet opening. Thus, the cleaning device is able to remove foreign bodies that are securely attached to the sensor. The invention therefore makes it possible to perform a function of using air to clean at least one sensor.

According to one embodiment, the inlet opening of the duct is in aeraulic communication with the discharge orifice of the air stream generator.

According to one embodiment, the discharge orifice is arranged radially in relation to an axis of rotation of a propeller of the air stream generator.

According to one embodiment, the discharge orifice develops in a plane perpendicular to an overall flow direction of the air stream.

According to one embodiment, the air stream generator comprises an air intake orifice extending in a plane perpendicular to an axis of rotation of a propeller of the air stream generator.

According to one embodiment, the air stream generator is a radial fan.

According to one embodiment, the duct comprises at least one channel connecting the inlet opening to an outlet opening, for the air stream, of the channel, and at least one nozzle connecting the outlet orifice to an inlet orifice, for the air stream, of the nozzle, the inlet orifice of the nozzle facing the outlet opening of the channel. Thus, the channel can be standard and the nozzle can be adapted to the specific features of the sensor to be cleaned. It is then also easier to integrate the cleaning device in a vehicle whilst still having as many standard components as possible. Lastly, the performance of the cleaning device on the basis of the operating conditions required, such as, for example, droplet size, rainwater flow rate, or else vehicle speed, can moreover be optimized for any type of sensor used in the vehicle.

According to one embodiment, the duct comprises a sleeve for holding the nozzle at the channel.

According to one embodiment, the sleeve is formed integrally with the channel.

Here, and throughout the following text, the term “formed integrally” should be understood as meaning that the elements that are formed integrally form a single component and are therefore made of the same material or materials. This component can be obtained for example by molding or by injection molding. This component therefore differs from elements that are joined together by welding or bonding.

According to one embodiment, the sleeve is formed integrally with the nozzle.

According to one embodiment, the duct has a length less than or equal to 250 mm, preferably less than or equal to 200 mm, preferably less than or equal to 150 mm. The length is measured along a line of the current of the air stream extending between the inlet opening and the outlet orifice of the duct.

According to one embodiment, the channel has an internal cross section which decreases from the inlet opening to the outlet opening, the internal cross section being measured in a plane perpendicular to the overall flow direction of the air stream in the channel.

Here, and throughout the following text, the term “internal cross section of the channel” should be understood as corresponding to the cross section of the hollow portion of the channel as seen in a plane perpendicular to the overall flow direction of the air stream in the channel. This makes it possible to target a camera that is at a distance from the outlet orifice of the nozzle.

According to one embodiment, the internal cross section of the channel decreases continuously.

According to one embodiment, the internal cross section of the channel decreases gradually. In other words, the internal cross section of the channel is constant over a first portion of the channel and then becomes smaller and remains constant over a second portion of the channel.

According to one embodiment, the outlet orifice of the nozzle has an outline which develops in a plane intersecting a plane of extent of a surface of the sensor.

According to one embodiment, the outlet orifice develops in a plane intersecting a plane in which the inlet orifice extends.

According to one embodiment, an internal cross section of the nozzle decreases from the inlet orifice to the outlet orifice. The internal cross section is measured in a plane perpendicular to the overall flow direction of the air stream in the nozzle.

Here, and throughout the following text, the term “internal cross section of the nozzle” should be understood as corresponding to the cross section of the hollow portion of the nozzle as seen in a plane perpendicular to the overall flow direction of the air stream in the nozzle. This makes it possible to target a camera that is at a distance from the outlet orifice of the nozzle.

According to one embodiment, the internal cross section of the nozzle decreases continuously.

According to one embodiment, the internal cross section of the nozzle decreases gradually. In other words, the internal cross section of the nozzle is constant over a first portion of the nozzle and then becomes smaller and remains constant over a second portion of the nozzle.

According to one embodiment, the nozzle comprises a ventilation grille extending in a plane perpendicular to an overall flow direction of the air stream in the nozzle.

According to one embodiment, the ventilation grille is arranged at the outlet orifice.

According to one embodiment, the cleaning device according to the invention comprises at least one heating element for heating the air stream circulating in the duct. The heating element makes it possible to increase the temperature of the air stream passing through the duct. An outer surface of the sensor can thus be dried more quickly, this being useful notably in the case of gel.

According to one embodiment, the heating element is arranged on the inside of the duct and on a wall of the duct.

According to one embodiment, the heating element is disposed on the inside of the nozzle and on a wall of the nozzle.

According to one embodiment, a distance between the heating element and the outlet orifice is less than or equal to 50 mm, preferably less than or equal to 10 mm.

According to one embodiment, the invention furthermore provides an assembly of at least two cleaning devices according to the invention, wherein the channel of one of the cleaning devices has an identical shape to a channel of at least one other one of the cleaning devices, and in that the nozzle of one of the cleaning devices has a different shape to a nozzle of at least one other one of the cleaning devices.

According to one embodiment, the channel is a standard component. For specification with the preceding paragraph.

According to one embodiment, the invention moreover provides a driving assistance module for a vehicle, comprising at least one sensor and at least one cleaning device according to the invention.

According to one embodiment, the sensor is configured to command the cleaning device to start up.

According to one embodiment, the sensor is a rainwater detector.

According to one embodiment, the sensor is a camera.

According to one embodiment, the driving assistance module comprises a cleaning liquid spraying device for cleaning at least one surface of the sensor, the cleaning device being configured to dry the surface of the sensor.

According to one embodiment, the outlet orifice of the duct is configured such that the air stream sweeps a receiving and/or transmitting outer surface of the sensor.

According to one embodiment, the sensor is a first sensor, the duct is a first duct, the driving assistance module comprises a second sensor, the cleaning device comprising a second duct for conveying the air stream over the second sensor from the discharge orifice of the air stream generator.

According to one embodiment, the second duct has at least one second inlet opening for the air stream and at least one second outlet orifice for the air stream, and a cross section of the second inlet opening of the second duct is larger than a cross section of the second outlet orifice of the second duct.

According to one embodiment, the second duct comprises at least one second channel connecting the second inlet opening to a second outlet opening, for the air stream, of the second channel, and at least one second nozzle connecting the second outlet orifice to a second inlet orifice, for the air stream, of the second nozzle, the second inlet orifice of the second nozzle facing the second outlet opening of the second channel.

According to one embodiment, the second duct comprises a second sleeve for holding the second nozzle at the second channel.

According to one embodiment, the second sleeve is formed integrally with the second channel.

According to one embodiment, the second sleeve is formed integrally with the second nozzle.

According to one embodiment, the second duct has a length less than or equal to 250 mm, preferably less than or equal to 200 mm, preferably less than or equal to 150 mm. The length is measured along a line of the current of the air stream extending between the second inlet opening and the second outlet orifice of the duct.

According to one embodiment, the second channel has an internal cross section which decreases from the second inlet opening to the second outlet opening, the internal cross section being measured in a plane perpendicular to the overall flow direction of the air stream in the second channel.

Here, and throughout the following text, the term “internal cross section of the second channel” should be understood as corresponding to the cross section of the hollow portion of the second channel as seen in a plane perpendicular to the overall flow direction of the air stream in the second channel. This makes it possible to target a camera that is at a distance from the second outlet orifice of the second nozzle.

According to one embodiment, the internal cross section of the second channel decreases continuously.

According to one embodiment, the internal cross section of the second channel decreases gradually. In other words, the internal cross section of the second channel is constant over a first portion of the second channel and then becomes smaller and remains constant over a second portion of the second channel.

According to one embodiment, the second outlet orifice of the second nozzle has an outline which develops in a plane intersecting a plane of extent of a surface of the second sensor.

According to one embodiment, the second outlet orifice develops in a plane intersecting a plane in which the second inlet orifice extends.

According to one embodiment, an internal cross section of the second nozzle decreases from the second inlet orifice to the second outlet orifice. The internal cross section is measured in a plane perpendicular to the overall flow direction of the air stream in the second nozzle.

Here, and throughout the following text, the term “internal cross section of the second nozzle” should be understood as corresponding to the cross section of the hollow portion of the second nozzle as seen in a plane perpendicular to the overall flow direction of the air stream in the second nozzle. This makes it possible to target a camera that is at a distance from the second outlet orifice of the second nozzle.

According to one embodiment, the internal cross section of the second nozzle decreases continuously.

According to one embodiment, the internal cross section of the second nozzle decreases gradually. In other words, the internal cross section of the second nozzle is constant over a first portion of the second nozzle and then becomes smaller and remains constant over a second portion of the second nozzle.

According to one embodiment, the second nozzle comprises a ventilation grille extending in a plane perpendicular to an overall flow direction of the air stream in the second nozzle.

According to one embodiment, the ventilation grille of the second nozzle is arranged at the second outlet orifice.

According to one embodiment, the heating element is a first heating element and the cleaning device according to the invention comprises at least one second heating element for heating the air stream circulating in the second duct. The heating element makes it possible to increase the temperature of the air stream passing through the second duct. An outer surface of the second sensor can thus be dried more quickly, this being useful notably in the case of gel.

According to one embodiment, the second heating element is arranged on the inside of the second duct and on a wall of the second duct.

According to one embodiment, the second heating element is disposed on the inside of the second nozzle and on a wall of the second nozzle.

According to one embodiment, a distance between the second heating element and the second outlet orifice is less than or equal to 50 mm, preferably less than or equal to 10 mm.

According to one embodiment, a distance between the first sensor and the second sensor is less than or equal to 350 mm, preferably less than or equal to 300 mm, preferably less than or equal to 250 mm. The distance between the two sensors is measured along a straight line passing through the two sensors.

According to one embodiment, the invention lastly provides a vehicle comprising a driving assistance module according to the invention and/or at least one cleaning device according to the invention.

### BRIEF DESCRIPTION OF DRAWINGS

Further features and advantages of the invention will become more apparent both from the following description and from a plurality of non-limiting exemplary embodiments, given by way of indication, with reference to the attached schematic drawings, in which:

FIG. 1 is a schematic view, in perspective, of a driving assistance module for a vehicle, comprising a vehicle sensor cleaning device according to the invention;

FIG. 2 is a schematic view, in perspective, of an air stream generator of the cleaning device illustrated in FIG. 1;

FIG. 3 is a schematic view of air stream transport ducts of the cleaning device illustrated in FIG. 1, as seen from a first viewing angle;

FIG. 4 is a schematic view of the air stream transport ducts illustrated in FIG. 3, as seen from a second viewing angle;

FIG. 5 is a schematic view, in perspective, of a first nozzle of the cleaning device illustrated in FIG. 1, according to a first embodiment;

FIG. 6 is a schematic view, in perspective, of the first nozzle according to a second embodiment;

FIG. 7 is a schematic view, in perspective, of the first nozzle according to a third embodiment.

### DETAILED DESCRIPTION OF THE INVENTION

It should first of all be noted that, although the figures set out the invention in detail for its implementation, they may of course be used to better define the invention if necessary. It should also be noted that, in all of the figures, elements that are similar and/or perform the same function are indicated using the same numbering.

In the following description, a direction of a longitudinal axis L, a direction of a transverse axis T, and a direction of a vertical axis V are represented by a trihedron (L, T, V) in the figures. A horizontal plane is defined as being a plane perpendicular to the vertical axis V, a longitudinal plane is defined as being a plane perpendicular to the transverse axis T, and a transverse plane is defined as being a plane perpendicular to the longitudinal axis L.

FIG. 1 shows a perspective view of a driving assistance module for a vehicle, comprising a first sensor 7, a second sensor 9 and a cleaning device 2 that is used notably to clean at least the two sensors 7, 9. This cleaning device 2 could also be utilized for other sensors and/or other components located in a motor vehicle.

With reference to FIG. 1, the cleaning device 2 comprises an air stream generator 3, a first air stream transport duct 5 for conveying the air stream over the first sensor 9, and a second air stream transport duct 7 for conveying the air stream over the second sensor 11. The air stream generator 3, the two air stream transport ducts 5, 7 and the sensors 9, 11 are fastened to a support 13.

The air stream generator 3 is a radial flow fan. It comprises a casing 15 in which there are a driveshaft (not shown) and a propeller (not shown) that is secured to the driveshaft serving to set the propeller in rotation about an axis of rotation R. The axis of rotation R of the propeller is parallel to the vertical axis V. The propeller has a hub linked to the driveshaft and a plurality of blades. Each blade extends radially outward from the hub and the blades are positioned equidistantly around the hub. The rotational speed of the propeller is between 1000 rpm and 10 000 rpm, generating an air stream having a speed of between 0 m/s and 20 m/s.

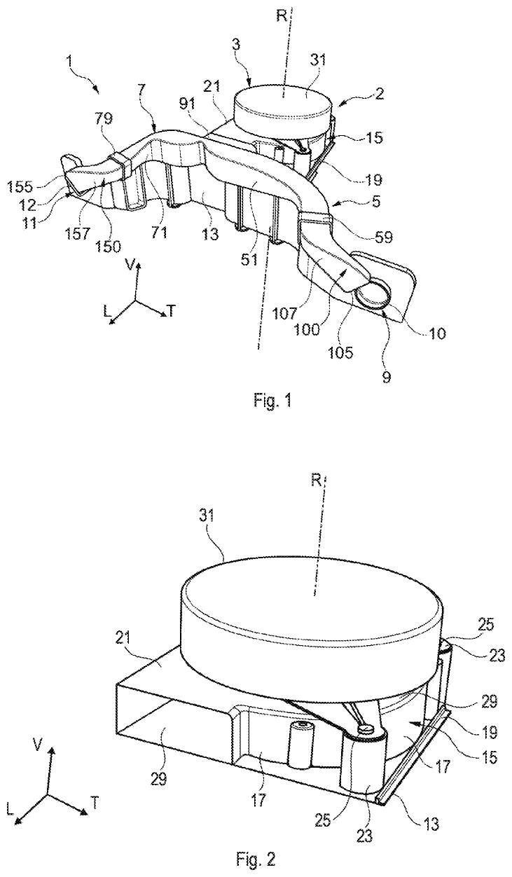

With reference to FIG. 2, the casing 15 is provided with four lateral walls 17 extending from a lower base 19 to an upper base 21 along the vertical axis V. The lower base 19 and the upper base 21 each extend in a plane of extent parallel to the horizontal plane defined above. The plane of extent of the lower base 19 is parallel to and does not intersect the plane of extent of the upper base 21.

In FIG. 2, the lower base 19 of the casing 15 develops in a plane of extent perpendicular to the axis of rotation R of the propeller and is therefore parallel to the horizontal plane. The lower base 19 has a square shape as seen in a plane perpendicular to the axis of rotation R of the propeller, that is to say as seen in the horizontal plane. The upper base 21 of the casing 15 develops in a plane of extent perpendicular to the axis of rotation R of the propeller and is therefore parallel to the horizontal plane. In the exemplary embodiment illustrated in FIG. 1 and in FIG. 2, the upper base 21 is parallel to the lower base 19 of the casing 15. The upper base 21 has a square shape as seen in a plane perpendicular to the axis of rotation R of the propeller, that is to say as seen in the horizontal plane. A length of a side of the lower base 19 and/or of the upper base 21 is substantially equal to 150 mm.

The casing 13 comprises three through-holes 23 extending along the vertical axis V. These holes 23 are threaded. The holes 23 are configured to interact with screws 25 so as to fasten the air stream generator 3 to the support 13. Each hole 23 is at an intersection between two contiguous lateral walls 17 of the casing 3.

With reference to FIG. 1 and FIG. 2, the air stream generator 3 comprises an intake orifice 27 for the air stream and a discharge orifice 29 for the air stream in aeraulic connection with the first duct 5 and the second duct 7. Setting the propeller of the air stream generator 3 in rotation makes it possible to aspirate the air from an external environment of the cleaning device 1 through the intake orifice 27, and makes it possible to expel the air stream produced through the discharge orifice 29. When the propeller of the air stream generator 3 is set in rotation, the air therefore circulates from the intake orifice 27 to the discharge orifice 29 in the direction of the ducts 5, 7.

The intake orifice 27 is delimited by an opening formed in the upper base 21. The intake orifice 27 has an outline of circular shape as seen in the horizontal plane. The intake orifice 27 is provided with a cover 31 in order to limit the entry of dust and/or foreign bodies into the air stream generator 3.

The discharge orifice 29 is delimited by an opening formed in one of the lateral walls 17. Thus, the discharge orifice 29 is arranged radially in relation to the axis of rotation R of the propeller of the air stream generator 3. The discharge orifice 29 has an outline of rectangular shape as seen in a plane perpendicular to an overall flow direction of the air stream.

The air stream generator 3 is configured to be controlled in terms of its power. The control of the air stream generator 3 can be slaved to at least one of the sensors 9, 11 in order to make a decision on the starting up of the air stream generator 3 and/or adjust the air stream on the basis of the dirtiness of at least one of the sensors 9, 11 and/or the environmental conditions, such as for example rain.

In an embodiment which is not shown, the air stream generator 3 is supplied with electricity by the electric battery of the vehicle via an electric cable provided with a connector. In another embodiment which is not shown, the air stream generator is supplied with electricity by photovoltaic cells on board the vehicle.

As illustrated in FIG. 1, the discharge orifice 29 of the air stream generator 3 is in aeraulic communication with the first duct 5 and the second duct 7.

With reference to FIG. 1, the first duct 5 has at least one first inlet opening 53 for the air stream and at least one first outlet orifice 105 for the air stream to leave through and pass over the first sensor 9. The first duct 5 has a length less than or equal to 500 mm. The length is measured along a line of the current of the air stream extending between the first inlet opening 53 of the first duct 5 and the first outlet orifice 105 of the first duct 5.

With reference to FIG. 1, the first duct 5 comprises a first channel 51 and a first nozzle 100 according to a first embodiment.

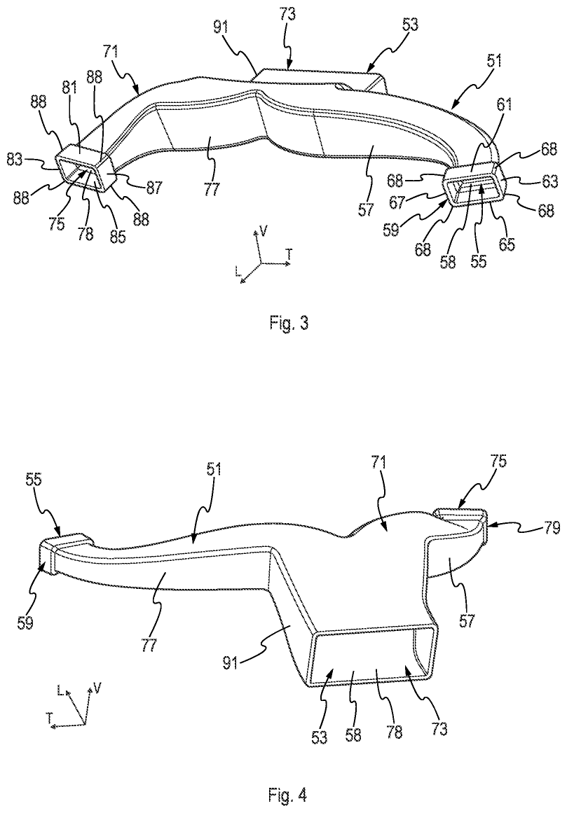

With reference to FIG. 3 and FIG. 4, the first channel 51 connects the first inlet opening 53 to a first outlet opening 55. Between the first inlet opening 53 and the first outlet opening 55, the first channel 51 has a curved shape as seen in a plane comprising the overall flow direction of the air stream in the first channel 51. The curve has a radius of curvature of between 10 mm and 100 mm, the radius of curvature being measured in a plane comprising the overall flow direction of the air stream in the first channel 51.

The first channel 51 has an internal cross section which decreases from the first inlet opening 53 to the first outlet opening 55, the internal cross section being measured in a plane perpendicular to the overall flow direction of the air stream in the first channel 51. The internal cross section of the first channel 51 corresponds to the cross section of the hollow portion of the first channel 51 as seen in a plane perpendicular to the overall flow direction of the air stream in the first channel 51. The internal cross section of the first channel 51 decreases continuously. In an embodiment which is not shown, the internal cross section of the first channel 51 decreases gradually.

The first channel 51 comprises a wall 57 which connects the first inlet opening 53 for the air stream to the first outlet opening 55 for the air stream. The wall 57 has an internal face 58 which is smooth. In other words, the internal face 58 of the first channel 51 does not have any irregularities. This makes it possible to limit pressure drops. The internal face 58 of the first channel 51 does not have any sharp edge corners, thereby also making it possible to limit pressure drops.

The first inlet opening 53 of the first channel 51, and therefore of the first duct 5, develops in a plane of extent perpendicular to the overall flow direction of the air stream at the first inlet opening 53. The first inlet opening 53 has an outline of rectangular shape with rounded corners as seen in a plane perpendicular to the overall flow direction of the air stream at the first inlet opening 53. The cross section of the first inlet opening 53, as seen in a plane perpendicular to the overall flow direction of the air stream at the first inlet opening 53, is smaller than or equal to the cross section of the discharge orifice 29 as seen in a plane perpendicular to the overall flow direction of the air stream at the discharge orifice 29. Thus, the first channel 51 and therefore the first duct 5 can be inserted into the air stream generator 3 at the first discharge orifice 29. In this case, the insertion is performed forcibly. In an embodiment which is not shown, the discharge orifice 29 is attached to the first inlet opening 53 via a third-party component.

The first outlet opening 55 of the first channel 51 extends in a plane of extent perpendicular to the overall flow direction of the air stream at the first outlet opening 55. The plane of extent of the first outlet opening 55 intersects the plane of extent of the first inlet opening 53. In an embodiment which is not illustrated, these planes of extent are parallel and do not intersect.

The first outlet opening 55 has an outline of rectangular shape with rounded corners as seen in a plane perpendicular to the overall flow direction of the air stream at the first outlet opening 55. The cross section of the first inlet opening 53 of the first duct 51, as seen in a plane perpendicular to the overall flow direction of the air stream at the first inlet opening 53, is larger than or equal to a cross section of the first outlet opening 55 as seen in a plane perpendicular to the overall flow direction of the air stream at the first outlet opening 55.

With reference to FIG. 3, the first channel 51 comprises a first sleeve 59 which extends from the outline of the first outlet opening 55 of the first channel 51 to the first nozzle 100 in a direction parallel to the overall flow direction of the air stream at the first sleeve 59. The first sleeve 59 is formed integrally with the first channel 51. In an embodiment which is not shown, the first sleeve 59 is an added component.

The first sleeve 59 is formed of four substantially flat sections 61, 63, 65, 67 which together delimit a housing for at least partially receiving the first nozzle 100. More specifically, the sections 61, 63, 65, 67 meet at edge corners 68. The sections 61, 63, 65, 67 together form a rectangular parallelepiped. The sections 61, 63, 65, 67 have the same dimension in the overall flow direction of the air stream at the first sleeve 59. Thus, the first sleeve 59 ensures the first nozzle 100 is held at the first channel 51. Moreover, the first sleeve 59 enables aeraulic communication between the first outlet opening 55 of the first channel 51 and the first nozzle 100.

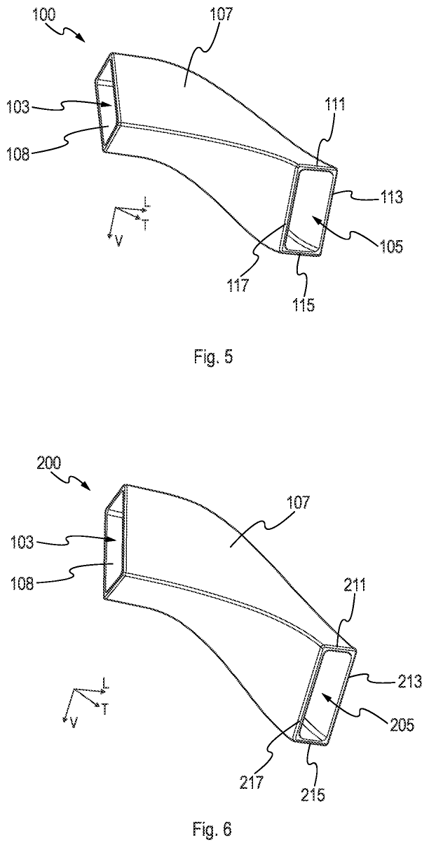

With reference to FIG. 5, the first nozzle 100, according to a first embodiment, connects a first inlet orifice 103 for the air stream to the first outlet orifice 105 for the air stream. The first nozzle 100 is held at the first channel 51 by the first sleeve 59, such that the first inlet orifice 103 of the first nozzle 100 faces the first outlet opening 55 of the first channel 51.

Between the first inlet orifice 103 and the first outlet orifice 105, the first nozzle 100 has a curved shape as seen in a plane comprising the overall flow direction of the air stream in the first nozzle 100. The curve has a radius of curvature of between 10 mm and 100 mm, the radius of curvature being measured in a plane comprising the overall flow direction of the air stream in the first nozzle 100.

The first nozzle 100 has an internal cross section which decreases from the first inlet orifice 103 to the first outlet orifice 105, the internal cross section being measured in a plane perpendicular to the overall flow direction of the air stream in the first nozzle 100. The internal cross section of the first nozzle 100 corresponds to the cross section of the hollow portion of the first nozzle 100 as seen in a plane perpendicular to the overall flow direction of the air stream in the first nozzle 100. The internal cross section of the first nozzle 100 decreases continuously. In an embodiment which is not shown, the internal cross section of the first nozzle 100 decreases gradually.

The first nozzle 100 comprises a wall 107 which connects the first inlet orifice 103 for the air stream to the first outlet orifice 105 for the air stream. The wall 107 of the first nozzle 100 has an internal face 108 which is smooth. In other words, the internal face 108 of the first nozzle 100 does not have any irregularities. This makes it possible to limit pressure drops. The internal face 108 of the first nozzle 100 does not have any sharp edge corners, thereby also making it possible to limit pressure drops.

The first inlet orifice 103 of the first nozzle 100 extends in a plane of extent perpendicular to the overall flow direction of the air stream at the first inlet orifice 103. The first inlet orifice 103 has an outline of rectangular shape with rounded corners as seen in a plane perpendicular to the overall flow direction of the air stream at the first inlet orifice 103.

The first outlet orifice 105 of the first nozzle 100 extends in a plane of extent perpendicular to the overall flow direction of the air stream at the first outlet orifice 105. The plane of extent of the first outlet orifice 105 intersects the plane of extent of the first inlet orifice 103. In an embodiment which is not illustrated, these planes of extent are parallel and do not intersect.

With reference to FIG. 1, FIG. 4 and FIG. 5, the plane of extent of the first outlet orifice 105 of the first nozzle 100 intersects the plane of extent of the first inlet opening 53 of the first channel 51. In an embodiment which is not illustrated, these planes of extent are parallel and do not intersect.

With reference to FIG. 5, the first outlet orifice 105 has an outline of rectangular shape with rounded corners as seen in a plane perpendicular to the overall flow direction of the air stream at the first outlet orifice 105. Thus, the outline is formed of two long edges 113, 117 that are substantially parallel to one another, and lateral edges 111, 115 that are substantially parallel to one another and perpendicular to the long edges 113, 117, and form the small sides of the outline.

The cross section of the first inlet orifice 103 of the first nozzle 100, as seen in a plane perpendicular to the overall flow direction of the air stream at the first inlet orifice 103, is larger than or equal to a cross section of the first outlet orifice 105 of the first nozzle 100, and therefore of the first duct 5, as seen in a plane perpendicular to the overall flow direction of the air stream at the first outlet orifice 105.

With reference to FIG. 3 and FIG. 5, the cross section of the first outlet orifice 105 of the first nozzle 100, and therefore of the first duct 5, as seen in a plane perpendicular to the overall flow direction of the air stream at the first outlet orifice 105 of the first nozzle 100, is smaller than the cross section of the first inlet opening 53 of the first channel 51, and therefore of the first duct 5, as seen in a plane perpendicular to the overall flow direction of the air stream at the first inlet opening 53 of the first channel 51.

With reference to FIG. 1, the first sensor 9 is disposed in the vicinity of the first outlet orifice 105 of the first nozzle 100 and therefore of the first duct 5. In other words, the air stream that is produced by the air stream generator 3 and leaves the first outlet orifice 105 can reach the first sensor 9. In this case, a distance between the first outlet orifice 105 and the first sensor is approximately 5 mm. The distance is measured along an axis perpendicular to the plane of extent of the first outlet orifice 105 of the duct 5. In an embodiment which is not illustrated, this length may be 50 mm.

With reference to FIG. 1, the first sensor 9 is a camera connected to at least one data acquisition system with which the vehicle is fitted. The first sensor 9 comprises a receiving and/or transmitting outer surface 10. The receiving and/or transmitting outer surface 10 protrudes from a surface of the vehicle, in this instance the support 13, toward an external environment of the vehicle. In other words, the receiving and/or transmitting optical surface 10 extends from a wall of the support 13 in a direction perpendicular to a plane of extent of the wall of the support 13.

The receiving and/or transmitting outer surface 10 of the first sensor 9 develops in a plane intersecting the plane of extent of the first outlet orifice 105 of the first nozzle 100.

In the example illustrated in FIG. 1, the first sensor 9 is configured to command the cleaning device 2 to start up. In other words, the operation of the cleaning device 2 is slaved to the first sensor 9.

With reference to FIG. 1, the second duct 7 of the cleaning device 2 has at least one second inlet opening 71 for the air stream and at least one second outlet orifice 155 for the air stream to leave through and pass over the second sensor 11. The second duct 7 has a length which is less than the first duct 5, that is to say a length less than 250 mm. The length is measured along a line of the current of the air stream extending between the second inlet opening 73 of the second duct 7 and the second outlet orifice 155 of the second duct 7.

With reference to FIG. 1, FIG. 3 and FIG. 4, the second duct 7 comprises a second channel 71 which connects the second inlet opening 73 to a second outlet opening 75, and a second nozzle 150 which connects a second inlet orifice 153 for the air stream to the second outlet orifice 155 for the air stream.

Between the second inlet opening 73 and the second outlet opening 75, the second channel 71 has a curved shape as seen in a plane comprising the overall flow direction of the air stream in the second channel 71. The curve has a radius of curvature of between 10 mm and 100 mm, the radius of curvature being measured in a plane comprising the overall flow direction of the air stream in the second channel 71.

The second channel 71 has an internal cross section which decreases from the second inlet opening 73 to the second outlet opening 75, the internal cross section being measured in a plane perpendicular to the overall flow direction of the air stream in the second channel 71. The internal cross section of the second channel 71 corresponds to the cross section of the hollow portion of the second channel 71 as seen in a plane perpendicular to the overall flow direction of the air stream in the second channel 71. The internal cross section of the second channel 71 decreases continuously. In an embodiment which is not shown, the internal cross section of the second channel 71 decreases gradually.

The second channel 71 comprises a wall 77 which connects the second inlet opening 73 for the air stream to the second outlet opening 75 for the air stream. The wall 77 has an internal face 78 which is smooth. In other words, the internal face 78 of the second channel 71 does not have any irregularities. This makes it possible to limit pressure drops. The internal face 78 of the second channel 51 does not have any sharp edge corners, thereby also making it possible to limit pressure drops.

The second inlet opening 73 of the second channel 71, and therefore of the second duct 7, develops in a plane of extent perpendicular to the overall flow direction of the air stream at the second inlet opening 53. The second inlet opening 53 has an outline of rectangular shape with rounded corners as seen in a plane perpendicular to the overall flow direction of the air stream at the second inlet opening 73. The cross section of the second inlet opening 71, as seen in a plane perpendicular to the overall flow direction of the air stream at the second inlet opening 73, is smaller than or equal to the cross section of the discharge orifice 29 as seen in a plane perpendicular to the overall flow direction of the air stream at the discharge orifice 29. Thus, the second channel 71 and therefore the second duct 7 can be inserted into the air stream generator 3 at the first discharge orifice 29. In this case, the insertion is performed forcibly. In an embodiment which is not shown, the discharge orifice 29 is attached to the second inlet opening 73 via a third-party component.

The second outlet opening 75 of the second channel 71 extends in a plane of extent perpendicular to an overall flow direction of the air stream at the second outlet opening 75. The plane of extent of the second outlet opening 75 intersects the plane of extent of the second inlet opening 73. In an embodiment which is not illustrated, these planes of extent are parallel and do not intersect.

The second outlet opening 75 has an outline of rectangular shape with rounded corners as seen in a plane perpendicular to the overall flow direction of the air stream at the second outlet opening 75. The cross section of the second inlet opening 73 of the second duct 71, as seen in a plane perpendicular to the overall flow direction of the air stream at the second inlet opening 73, is larger than or equal to a cross section of the second outlet opening 75 as seen in a plane perpendicular to the overall flow direction of the air stream at the second outlet opening 75.

With reference to FIG. 3, the second channel 71 comprises a second sleeve 79 which extends from the outline of the second outlet opening 75 of the first channel 71 to the second nozzle 150 in a direction parallel to the overall flow direction of the air stream at the second sleeve 79. The second sleeve 79 is formed integrally with the second channel 71.

The second sleeve 79 is formed of four substantially flat sections 81, 83, 85, 87 which together delimit a housing 89 for at least partially receiving the second nozzle 150. More specifically, the sections 81, 83, 85, 87 meet at edge corners 91. The sections 81, 83, 85, 87 together form a rectangular parallelepiped. The sections 81, 83, 85, 87 have the same dimension in the overall flow direction of the air stream at the second sleeve 79. Thus, the second sleeve 79 ensures the second nozzle 150 is held at the second channel 71. Moreover, the second sleeve 79 enables aeraulic communication between the second outlet opening 75 of the second channel 71 and a second inlet orifice 153 of the second nozzle 150.

With reference to FIG. 1, FIG. 3 and FIG. 4, the first duct 5 and the second duct 7 are configured to share a common inlet portion 91. This common inlet portion 91 comprises an inlet passage for the air stream coming from the air stream generator 3. The inlet passage for the air stream is formed by the first inlet opening 53 and by the second inlet opening 73, between which there is no separation. In addition, the common portion 91 is formed by a portion of the first channel 51 and a portion of the second inlet channel, between which there is no separation. Thus, the air stream produced by the air stream generator 3 first of all flows through the common part 91 then is directed specifically over each sensor by the first duct 5 by way of its first outlet orifice 105 and by the second duct 7 by way of its second outlet orifice 155.

In an embodiment which is not shown, the first inlet opening 53 of the first duct 5 and the second inlet opening 73 of the second duct 7 are separate. Where appropriate, the first inlet opening 53 and the second inlet opening 73 are arranged next to one another so as to face the discharge orifice 29 of the air stream generator 3. The discharge orifice 29 thus supplies the air stream to the two ducts through their respective and separate inlet openings.

With reference to FIG. 1, the second nozzle 150 connects a second inlet orifice (not shown) for the air stream to the second outlet orifice 155 for the air stream. The second nozzle 100 is held at the second channel 71 by the second sleeve 79, such that the second inlet orifice of the second nozzle 150 faces the second outlet opening 75 of the second channel 71.

Between the second inlet orifice and the second outlet orifice 155, the second nozzle 150 has a curved shape as seen in a plane comprising the overall flow direction of the air stream in the second nozzle 150. The curve has a radius of curvature of between 10 mm and 100 mm, the radius of curvature being measured in a plane comprising the overall flow direction of the air stream in the second nozzle 150.

The second nozzle 150 has an internal cross section which decreases from the second inlet orifice to the second outlet orifice 155, the internal cross section being measured in a plane perpendicular to the overall flow direction of the air stream in the second nozzle 150. The internal cross section of the second nozzle 150 corresponds to the cross section of the hollow portion of the second nozzle 150 as seen in a plane perpendicular to the overall flow direction of the air stream in the second nozzle 150. The internal cross section of the second nozzle 150 decreases continuously. In an embodiment which is not shown, the internal cross section of the second nozzle 150 decreases gradually.

The second nozzle 150 comprises a wall 157 which connects the second inlet orifice for the air stream to the second outlet orifice 155 for the air stream. The wall 157 of the second nozzle 150 has an internal face (not visible) which is smooth. In other words, the internal face of the second nozzle 150 does not have any irregularities. This makes it possible to limit pressure drops. The internal face of the second nozzle 150 does not have any sharp edge corners, thereby also making it possible to limit pressure drops.

The second inlet orifice of the second nozzle 150 extends in a plane of extent perpendicular to the overall flow direction of the air stream at the second inlet orifice. The second inlet orifice has an outline of rectangular shape with rounded corners as seen in a plane perpendicular to the overall flow direction of the air stream at the second inlet orifice.

The second outlet orifice 155 of the second nozzle 150 extends in a plane of extent perpendicular to the overall flow direction of the air stream at the second outlet orifice 155. The plane of extent of the second outlet orifice 155 intersects the plane of extent of the second inlet orifice. In an embodiment which is not illustrated, these planes of extent are parallel and do not intersect.

With reference to FIG. 1 and FIG. 4, the plane of extent of the second outlet orifice 155 of the second nozzle 150 intersects the plane of extent of the second inlet opening 73 of the second channel 71. In an embodiment which is not illustrated, these planes of extent are parallel and do not intersect.

With reference to FIG. 1, the second outlet orifice 155 has an outline of rectangular shape with rounded corners as seen in a plane perpendicular to the overall flow direction of the air stream at the second outlet orifice 155. The cross section of the second inlet orifice of the second nozzle 150, as seen in a plane perpendicular to the overall flow direction of the air stream at the second inlet orifice, is larger than or equal to a cross section of the second outlet orifice 155 of the second nozzle 150, and therefore of the second duct 7, as seen in a plane perpendicular to the overall flow direction of the air stream at the second outlet orifice 155.

With reference to FIG. 1, FIG. 3 and FIG. 4, the cross section of the second outlet orifice 155 of the second nozzle 150, and therefore of the second duct 7, as seen in a plane perpendicular to the overall flow direction of the air stream at the second outlet orifice 155 of the second nozzle 150, is smaller than the cross section of the second inlet opening 73 of the second channel 71, and therefore of the second duct 7, as seen in a plane perpendicular to the overall flow direction of the air stream at the second outlet opening 73 of the second channel 71.

With reference to FIG. 1, the first nozzle 100 and the second nozzle 150 have different shapes, and therefore do not have the same shape.

With reference to FIG. 1, the second sensor 11 is disposed in the vicinity of the second outlet orifice 155 of the second nozzle 150 and therefore of the second duct 7. In other words, the air stream that is produced by the air stream generator 3 and leaves the second outlet orifice 155 can reach the sensor 11. In this case, a distance between the second outlet orifice 155 and the second sensor is approximately 5 mm. The distance is measured along an axis perpendicular to the plane of extent of the second outlet orifice 155 of the duct 7. In an embodiment which is not illustrated, this length may be 50 mm.

With reference to FIG. 1, the second sensor 11 is a rainwater detector connected to at least one data acquisition system with which the vehicle is fitted. The second sensor 11 comprises a receiving and/or transmitting outer surface 12. The receiving and/or transmitting outer surface 12 protrudes from a surface of the vehicle, in this instance the support 13, toward an external environment of the vehicle. In other words, the receiving and/or transmitting optical surface 12 extends from a wall of the support 13 in a direction perpendicular to a plane of extent of the wall of the support 13.

The receiving and/or transmitting outer surface 12 of the sensor 11 develops in a plane intersecting the plane of extent of the second outlet orifice 155 of the second nozzle 150.

In an example which is not illustrated, the second sensor 11 is configured to command the cleaning device 2 to start up.

With reference to FIG. 1, a distance between the first sensor 9 and the second sensor 11 is substantially equal to 350 mm. It can be preferable for this distance to be less than or equal to 300 mm, and more particularly less than or equal to 250 mm. The distance between the two sensors is measured along a straight line passing through the two sensors.

The method for operating the cleaning device will now be described. When the first sensor 9, that is to say a camera, detects foreign bodies on its receiving and/or transmitting outer surface 10, it sends a signal to the data acquisition system of the vehicle, which then actuates the air stream generator 3. The air stream generator produces an air stream which leaves the fan through the discharge orifice 29 and then enters the air stream transport ducts 5, 7 through the first inlet opening 53 and the second inlet opening 73. The ducts 5, 7 guide the air streams to the sensors 9, 11. The air stream leaves the ducts 5, 7 through the first outlet orifice 105, 205, 305 and through the second outlet orifice 155. The first outlet orifice 105, 205, 305 makes it possible to orient the air stream onto the receiving and/or transmitting outer surface 10 of the first sensor 9 in order to entrain the foreign bodies on the receiving and/or transmitting outer surface 10 of the first sensor 9. At the same time, the second outlet orifice 155 makes it possible to orient the air stream onto the receiving and/or transmitting outer surface 12 of the second sensor 11 in order to entrain any foreign bodies located there.

If the foreign bodies are not removed from the receiving and/or transmitting outer surface 10 of the first sensor 9 by the air stream, the data acquisition system can increase the rotational speed of the propeller of the air stream generator 3 in order for the air stream to be more powerful.

The cleaning device 2 may also be actuated directly by an operation when the vehicle is at a standstill or when it is in operation.

FIG. 6 illustrates the first nozzle according to a second embodiment. This second embodiment aims to enable the air stream leaving the outlet orifice to reach a receiving and/or transmitting outer surface of a sensor which is further away from the first outlet orifice than in the first embodiment. The first nozzle 200 according to the second embodiment is identical to the first nozzle 100 according to the first embodiment, except for the first outlet orifice. For the elements that are identical, reference will be made to the description of FIG. 1 and FIG. 5 above.

With reference to FIG. 6, the first outlet orifice 205 has an outline of rectangular shape with rounded corners as seen in a plane perpendicular to the overall flow direction of the air stream at the first outlet orifice 205 of the first nozzle 200 according to the second embodiment. Thus, the outline is formed of two long edges 213, 217 that are substantially parallel to one another, and lateral edges 211, 215 that are substantially parallel to one another and perpendicular to the long edges 213, 217, and form the small sides of the outline of the first outlet orifice 205.

The two long edges 213, 217 of the outline of the first outlet orifice 205 of the second embodiment have a longer length than that of the two long edges 113, 117 of the outline of the first outlet orifice 105 of the first embodiment. The two lateral edges 211, 215 of the outline of the first outlet orifice 205 of the second embodiment have a shorter length than that of the two lateral edges 111, 115 of the outline of the first outlet orifice 105 of the first embodiment. The shape of the outline of the first outlet orifice 205 of the second embodiment promotes a more laminar flow over the receiving and/or transmitting outer surface of the sensor 9 than does the shape of the contour of the first outlet orifice 105 of the first embodiment. The air stream from the air stream generator can thus reach the receiving and/or transmitting outer surface 10 of the first sensor 9 even if the receiving and/or transmitting outer surface 10 is further away and before the air stream diffuses into the ambient air.

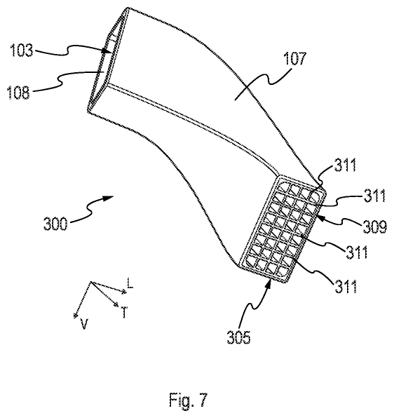

FIG. 7 shows the first nozzle in a third embodiment. This third embodiment makes it possible to target a receiving and/or transmitting outer surface of a sensor that is even further away from the first outlet orifice than in the second embodiment. The first nozzle 300 according to the third embodiment is identical to the first nozzle 100 of the first embodiment, except for the first outlet orifice. For the elements that are identical, reference will be made to the description of FIG. 1 and FIG. 5 above.

With reference to FIG. 7, the first nozzle 300 comprises a ventilation grille 309. The ventilation grille 309 is arranged at the first outlet orifice 305 of the first nozzle 305. The ventilation grille 309 comprises bars 311 disposed in a grid. In other words, the ventilation grille 309 is a lattice. The ventilation grille 309 makes it possible to ensure an air stream which is as laminar as possible for the purpose of reaching the receiving and/or transmitting outer surface 10 of the first sensor 9 even if the receiving and/or transmitting outer surface 10 is further away and before the air stream diffuses into the ambient air. This enables proper targeting, even when the first sensor 9 is far away from the first outlet orifice 305.

The ventilation grille 309 is formed integrally with the wall 107 of the first nozzle 300.

The second nozzle 150 may be designed to adopt at least one of the features of the three embodiments of the first nozzle 100, 200, 300. For example, the second nozzle 150 could incorporate a ventilation grille like the one described in the third embodiment of the first nozzle 100.

The cleaning device 2 can thus easily be adapted to the specific features of a surface of a sensor to be cleaned in order to optimize the performance of the system on the basis of the operating conditions required, since all that needs to be done is to adapt the one or more nozzles.

Depending on the type of sensor used in a driving assistance module, for example during the manufacture of the driving assistance module or during an operation for improving the latter, it is possible to adapt the cleaning device 2 by only adapting the nozzles.

In an embodiment which is not shown, the cleaning device 2 comprises at least one heating element for heating the air stream circulating in at least one of the two ducts 5, 7. The heating element may be a resistor or a heating film. The heating element makes it possible to increase the temperature of the air stream passing through at least one of the two ducts 5, 7.

In an embodiment which is not shown, the heating element is arranged on the inside of at least one of the two ducts 5, 7. The heating element may be arranged on an internal face and on an internal face 58, 78 of at least one of the channels 51, 71 of the ducts 5, 7 or on an internal face 108, 158 of at least one of the nozzles 100, 150, 200, 300 of the ducts 5, 7.

A distance between the heating element and the first outlet orifice 105, 205, 305 is less than or equal to 50 mm, preferably less than or equal to 10 mm, if the heating element is positioned on the inside of the first duct 5. A distance between the heating element and the second outlet orifice 155 is less than or equal to 50 mm, preferably less than or equal to 10 mm, if the heating element is positioned on the inside of the second duct 7.

Of course, the invention is not limited to the examples that have just been described, and numerous modifications may be made to these examples without departing from the scope of the invention.

What is claimed is:

1. A cleaning device for at least one vehicle sensor, comprising at least one air stream generator, at least one air stream transport duct for conveying the air stream over the sensor from a discharge orifice of the air stream generator, the duct having at least one inlet opening for the air stream and at least one outlet orifice for the air stream, wherein a cross section of the inlet opening of the duct is larger than a cross section of the outlet orifice of the duct.

2. The cleaning device as claimed in claim 1, wherein the duct includes at least one channel connecting the inlet opening to an outlet opening, for the air stream, of the channel, and at least one nozzle connecting the outlet orifice to an inlet orifice, for the air stream, of the nozzle, the inlet orifice of the nozzle facing the outlet opening of the channel.

3. The cleaning device as claimed in claim 2, wherein the duct includes a sleeve for holding the nozzle at the channel.

4. The cleaning device as claimed in claim 3, wherein an internal cross section of the nozzle decreases from the inlet orifice to the outlet orifice.

5. The cleaning device as claimed in claim 4, wherein the nozzle includes a ventilation grille extending in a plane perpendicular to an overall flow direction of the air stream in the nozzle.

6. A cleaning system, comprising at least two cleaning devices, with each of the a least two cleaning device including at least one air stream generator, at least one air stream transport duct for conveying the air stream over the sensor from a discharge orifice of the air stream generator, the duct having at least one inlet opening for the air stream and at least one outlet orifice for the air stream, wherein a cross section of the inlet opening of the duct is larger than a cross section of the outlet orifice of the duct, wherein a channel of one of the cleaning devices has an identical shape to a channel of at least one other one of the cleaning devices, and in that a nozzle of one of the cleaning devices has a different shape to a nozzle of at least one other one of the cleaning devices.

7. A driving assistance module for a vehicle, comprising at least one sensor and at least one cleaning device, with the cleaning device including at least one air stream generator, at least one air stream transport duct for conveying the air stream over the sensor from a discharge orifice of the air stream generator, the duct having at least one inlet opening for the air stream and at least one outlet orifice for the air stream, wherein a cross section of the inlet opening of the duct is larger than a cross section of the outlet orifice of the duct.

8. The driving assistance module as claimed in claim 7, wherein the sensor is configured to command the cleaning device to start up.

9. The driving assistance module as claimed in claim 7, wherein the outlet orifice of a nozzle is configured such that the air stream sweeps a receiving and/or transmitting outer surface of the sensor.

10. The driving assistance module as claimed in claim 7, wherein the sensor is a first sensor, the duct is a first duct, the driving assistance module includes a second sensor, the cleaning device includes a second duct for conveying the air stream over the second sensor from the discharge orifice of the air stream generator.
